(19) United States
(12) Patent Application Publication
(10) Pub. No.: US 2010/0295666 A1
(43) Pub. Date: Nov. 25, 2010

(54) Computer System Having RFID Reading/Writing Function

(76) Inventors: Sen-Fang Hsieh, Hsinchu (TW); Kuo-Hsin Tai, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/468,840

(22) Filed: May 19, 2009

(51) Int. Cl. H04Q 5/22

(52) U.S. Cl. 340/10.51

(57) ABSTRACT

A computer system having an RFID reading/writing function is provided. The computer system includes a computer device, and a modulized RFID reader. The modulized RFID reader is an RFID reader module integrated with functions and the circuit of the conventional RFID reader. The RFID reader module can be integrated inside the computer device. Therefore, the computer system of the present invention is multifunctional and has at least an RFID reading/writing function. As such, the modulized RFID reader is adapted for mass production, and is convenient for testing and assembling. Therefore, the modulized RFID reader can be provided to the customers with a much cheaper price.

### BACKGROUND OF THE INVENTION

1. Field of the Invention

The present invention relates generally to a computer system having a radio frequency identification (RFID) reading/writing function, and more particularly, to a computer system having a built-in modulized RFID reader.

2. The Prior Arts

Currently, in most circumstances, the material world and the information world are relatively independent one from another. Even though computer equipments have been widely used for obtaining information, the computer equipment must be handled by human being. However, if an object can be developed to have the capability of actively informing its related information, it may save a lot of manpower and reduce errors occurred during manually reading operation.

FIG. 1 is a schematic diagram illustrating an architecture of a conventional RFID system. Referring to FIG. 1, the RFID system includes an electronic tag, an RFID reader 30, and a computer host 50. The RFID reader 30 and the electronic tag 10 are adapted for transmitting or exchanging an identification program or information therebetween in a radio frequency (RF) manner. The information can be transmitted and exchanged between the RFID reader 30 and the computer host 50 via a suitable communication approach, e.g., RS-232 or USB.

The electronic tag 10 is adapted for saving setting information therein. When the electronic tag 10 senses an RF wave emitted from the RFID reader 30, an alternating magnetic field is generated to active the electronic tag 10 so as to save the setting information into the electronic tag 10 or read previously saved setting information back to the RFID reader 30, and finally the read setting information is transmitted to the computer host 50 and is provided to the user.

However, the conventional RFID system is usually very expansive. Despite the convenience of using the electronic tag of the conventional RFID system, prospective users are often deterred by the high cost of the entire system. In addition, the conventional RFID system must be operated together with a computer. When the computer is not a portable one, the conventional RFID system is restricted for certain locations only. As such, an RFID reader which is cheap, portable, and convenient is highly desired.

### SUMMARY OF THE INVENTION

A primary objective of the present invention is to provide a computer system having an RFID reading/writing function. The computer system includes a computer device, and a modulized RFID reader. The modulized RFID reader is an RFID reader module integrated with functions and the circuit of the conventional RFID reader. The RFID reader module can be integrated inside the computer device. Therefore, the computer system of the present invention is multifunctional and has at least an RFID reading/writing function.

A further objective of the present invention is to provide a computer system having an RFID reading/writing function. The computer system includes a computer device, and a modulized RFID reader. The modulized RFID reader is configured in a form of a chip or a module interface card. As such, the modulized RFID reader is adapted for mass production, and is convenient for testing and assembling. Therefore, the modulized RFID reader can be provided to the customers with a much cheaper price.

A still further objective of the present invention is to provide s computer system having an RFID reading/writing function. The computer system includes a computer device, and an RFID reader. The RFID reader is configured in a form of a chip or a module interface card, and is adapted for installing in a small computer device, e.g., a notebook computer or a mini notebook computer, so as to provide a portable computer device having the RFID reading/writing function.

As such, the present invention provides a solution to the difficulties of the conventional as mentioned above by providing a cheap, portable and convenient RFID reader.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating an architecture of a conventional RFID system; and

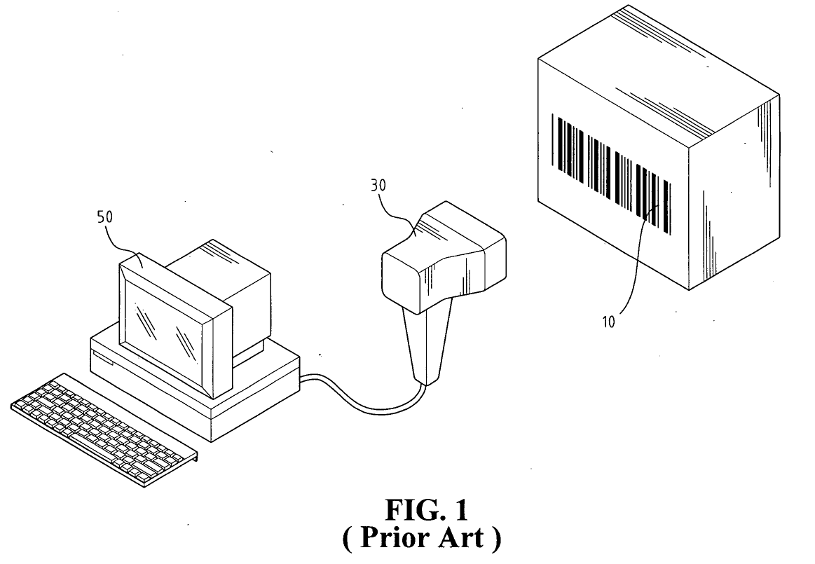

FIG. 2 is schematic diagram illustrating an architecture of a computer system having an RFID reading/writing function according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

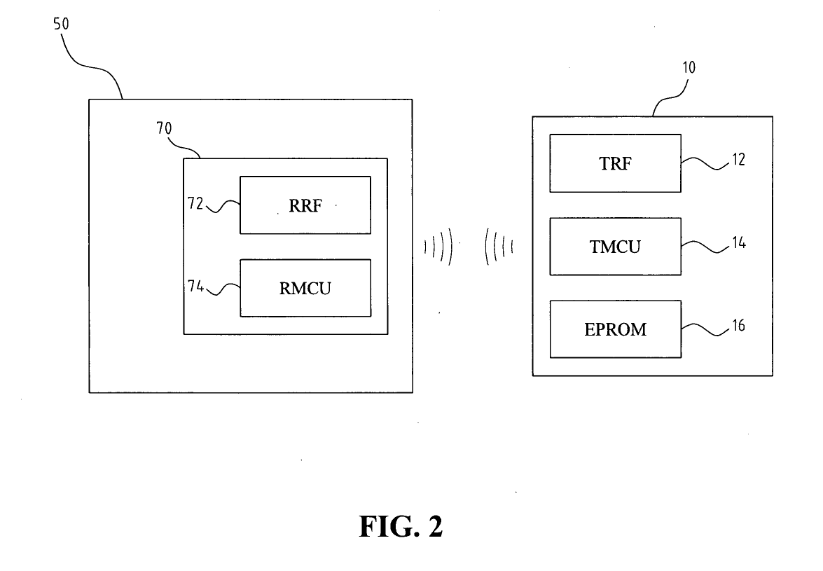

FIG. 2 is schematic diagram illustrating an architecture of a computer system having an RFID reading/writing function according to an embodiment of the present invention. Referring to FIG. 2, the present invention provides a computer system including a computer device 50 and a modulized RFID reader 70 assembled inside the computer device 50. The modulized RFID reader 70 is a chip or a module interface card including the circuit as well as the functions of the conventional RFID reader as discussed above integrated therein. In such a way, the chip or module interface card can be assembled to a certain assembly of the computer device 50. The assembly for example can be a main board or a controller circuit board.

The modulized RFID reader 70 is adapted for executing an identification program to an electronic tag 10, and reading setting information previously saved in the electronic tag 10. The modulized RFID reader 70 is further adapted for receiving user setting information transmitted from the computer device 50. After receiving the user setting information, the modulized RFID reader 70 actives the electronic tag 10 located within an effective sensing range by emitting an RF wave, so as to write the user setting information into the electronic tag 10. The effective sensing range for example can be ultrahigh frequency (UHF), very high frequency (VHF), high frequency (HF), medium frequency (MF), or low frequency (LF). In other words, the communication frequency of the RF wave ranges from 3 GHz to 30 KHz.

The modulized RFID reader 70 includes a reader radio frequency emitter module (RRF) 72, and a reader microcontroller unit (RMCU) 74. The electronic tag 30 includes an electronic tag radio frequency emitter module (TRF) 12, an electronic tag microcontroller unit (TMCU) 14, and an erasable programmable read only memory (EPROM) 16. The RRF 72 is adapted for emitting an RF wave to active the TRF 12 and the EPROM 16 within the effective sensing range. Therefore, the information saved in the EPROM 16 can be read and transmitted to the RRF 70, and finally transmitted back to the computer device 50, and provided to the user for subsequent processing.

Alternatively, the user can also input user setting information to the computer device 50. When the modulized RFID reader 70 receives the user setting information from the computer device 50, the RRF 72 emits an RF wave to active the TRF 12 and the EPROM 16 within the effective sensing range. Therefore, the user setting information is received by the EPROM 16 and saved therein.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A computer system having a radio frequency identification (RFID) reading/writing function, comprising:
a computer device, allowing a user to input a user setting information; and
a modulized RFID reader, secured to an assembly inside the computer device, for receiving the user setting information inputted by the user, wherein the modulized RFID reader comprises a reader radio frequency emitter module (RRF) for emitting the user setting information in a form of radio frequency (RF) wave,
wherein when an electronic tag is located within an effective sensing range of the modulized RFID reader, the electronic tag receives the user setting information, and the user setting information is saved into the electronic tag, and meanwhile the modulized RFID reader is capable of reading setting information previously saved in electronic tag.

2. The computer system according to claim 1, wherein the assembly is a main board or a circuit board.

3. The computer system according to claim 1, wherein the computer device is a desktop computer, a notebook computer, or a mini notebook computer.

4. The computer system according to claim 1, wherein the modulized RFID reader is configured in a form of a chip or a module interface card.

5. The computer system according to claim 1, wherein the RF wave has a communication frequency ranging from 3 GHz to 30 KHz.
